(19) United States
(12) Patent Application Publication
(10) Pub. No.: US 2010/0032922 A1
(43) Pub. Date: Feb. 11, 2010

(54) Trailer storage assembly and a trailer having such an assembly

(76) Inventor: Phillip Bernard Brodak, Holly, MI (US)

Correspondence Address: John G. Chupa;Law Offices of John Chupa and Associates, P.C., Suite 50, 28535 Orchard Lake Rd., Farmington Hills, MI, 48334, US

(21) Appl. No.: 12/221,862

(22) Filed: Aug. 7, 2008

(51) Int. Cl. B62D 63/08

(52) U.S. Cl. 280/400; 280/769; 280/656

(57) ABSTRACT

A trailer 10 having a trailer assembly 20 which is adapted to be deployed on a tongue 12 and which provides a storage box 170 and a container 180.

### GENERAL BACKGROUND

1. Field of the Invention

The present invention generally relates to a trailer storage assembly and a to a trailer having such an assembly and more particularly, to a storage assembly which may be added to a trailer and/or sold as part of an overall trailer assembly and which allows items to be selectively and securely stored and removed from the trailer assembly.

2. Background of the Invention

Trailers are typically and generally used to haul or transport an item, such as by way of example and without limitation a boat or a log splitter, to a certain location where the hauled item is utilized in a particular and desired manner. While many types of trailers exist, a particular type includes an item supporting and/or carrying platform, a tongue portion which is adapted to be selectively attached to a selectively movable apparatus, such as by way of example and without limitation a car or truck, and which is further coupled to and/or integrally formed with the platform, and a wheel assembly which is generally coupled to the item carrying platform and which allows the entire trailer to be easily transported or moved.

While these trailers do allow items to be carried or transported, they generally lack storage facilities or space. Typically, when the transported item is moved to a certain location, there is a requirement and/or a desire to not only utilize the transported item, but also to concomitantly utilize a wide variety of other items (i.e., spare parts and/or oil/gas tools and/or gasoline and/or safety equipment are highly desired to be transported with a log a splitter, boat, a recreational vehicle, and/or other such apparatus). Thus, it is highly desirable to have a relatively large amount of storage space, which such trailers do not typically provide. The present invention addresses this and other drawbacks and provide a new and novel trailer storage assembly.

### SUMMARY OF THE INVENTION

It is a first non-limiting object of the present invention to provide a trailer assembly which overcomes some or all of the previously delineated drawbacks of trailers which are delineated above.

It is a second non-limiting object of the present invention to provide a trailer storage assembly which may be selectively coupled to a trailer and which provides additional storage space for a user of the trailer.

According to a first non-limiting aspect of the present invention a trailer is provided and includes a tongue portion; a wheel assembly which is coupled to the tongue portion; a first plate having a longitudinal axis of symmetry and which abuttingly engages a first surface of the tongue portion and which includes four substantially identical elliptically shaped openings, wherein a first pair of the four substantially identical elliptically shaped openings reside on a second axis which is perpendicular to the longitudinal axis of symmetry, wherein the first surface further including a second pair of elliptically shaped openings and wherein the second pair of the four substantially identical elliptically shaped openings reside on a third axis which is perpendicular to the longitudinal axis of symmetry and parallel to the second axis and wherein the tongue portion lies along the longitudinal axis of symmetry; first and second substantially identical L-shaped members, wherein a first of the L-shaped members has a first planar surface which abuttingly engages the tongue portion and a second projecting surface which is parallel to and which overlays the first plate, wherein the second projecting surface includes fifth and sixth substantially identical elliptically shaped openings and wherein the fifth elliptically shaped opening communicates with and overlays a unique one of the first pair of the four substantially identical elliptically shaped openings, wherein the sixth elliptically shaped opening communicates with and overlays a second one of the first pair of the four substantially identical elliptically shaped openings, and wherein the second of the L-shaped members has a first planar surface which abutingly engages the tongue portion and a second projecting surface which is parallel to and which overlays the first plate, wherein the second projecting surface of the second L-shaped member includes seventh and eighth substantial identical elliptically shaped openings and wherein the seventh elliptically shaped opening communicates with and overlays a unique one of the second pair of the four substantially identical elliptically shaped openings, wherein the eighth elliptically shaped opening communicates with a second one of the second pair of the four substantially identical elliptically shaped openings; a second plate which abuttingly engages and overlays the respective second projecting surface of the first and second L-shaped members, wherein said second plate includes substantially identical ninth, tenth, eleventh, and twelfth generally elliptical openings and wherein the ninth opening communicates with, is registered with, and overlays said fifth opening, the tenth opening communicates with, is registered with, and overlays said sixth opening, the eleventh opening communicates with, is registered with and overlays said seventh opening, and the twelfth opening communicates with, is registered with, and overlays said eighth opening; and first, second, third, and fourth substantially identical fasteners, which respectively and fastenably transverse a unique pair of registered elliptically shaped openings and which cooperatively fasten the first plate to the second plate and the L-shaped members to the second plate.

According to a second non-limiting aspect of the present invention a trailer storage assembly for use in combination with a trailer of the type having a tongue and a wheel assembly which is coupled to the tongue, is provided. The trailer storage assembly includes a first plate having a longitudinal axis of symmetry and which abuttingly engages a first surface of the tongue portion and which includes four substantially identical elliptically shaped openings, wherein a first pair of the four substantially identical elliptically shaped openings reside on a second axis which is perpendicular to the longitudinal axis of symmetry and wherein the second axis comprises a longitudinal axis of symmetry of the first pair of elliptically shaped openings, the first surface further including a second pair of elliptically shaped openings and wherein the second pair of the four substantially identical elliptically shaped openings reside on a third axis which is perpendicular to the longitudinal axis of symmetry and parallel to the second axis and wherein the tongue portion lies along the longitudinal axis of symmetry; first and second substantially identical L-shaped members, wherein a first of the L-shaped members has a first planar surface which abuttingly engage the tongue portion and a second projecting surface which is parallel to and which overlays the first plate, wherein the second projecting surface includes fifth and sixth substantially identical elliptically shaped openings and wherein the fifth elliptically shaped opening communicates with and overlays a unique one of the first pair of the four substantially identical elliptically shaped openings, wherein the sixth elliptically shaped opening communicates with and overlays a second one of the first pair of the four substantially identical elliptically shaped openings, and wherein the second of the L-shaped members has a first planar surface which abutingly engages the tongue portion and a second projecting surface which is parallel to and which overlays the first plate, wherein the second projecting surface of the second L-shaped member includes seventh and eighth substantial identical elliptically shaped openings and wherein the seventh elliptically shaped opening communicates with and overlays a unique one of the second pair of the four substantially identical elliptically shaped openings, wherein the eighth elliptically shaped opening communicates with and overlays a second one of the second pair of the four substantially identical elliptically shaped openings; a second plate which abuttingly engages and overlays the respective second projecting surface of the first and second L-shaped members; and first, second, third, and fourth substantially identical fasteners, which respective and fastenably transverse a unique pair of the registered elliptically shaped openings and which cooperatively fasten the first plate to the second plate and the L-shaped members to the second plate.

According to a third non-limiting embodiment, a trailer assembly for use with a trailer of the type having a tongue is provided. The trailer assembly comprises a plate which engages the tongue; and a pair of fasteners which fasten the plate to the tongue.

These and other features, aspects, and advantages of the present invention will become apparent from a reading of the following detailed description of the preferred embodiment of the invention including the subjoined claims and by reference to the following drawings.

### BRIEF DESCRIPTION OF THE DRAWINGS

FIG. 1 is a front perspective view of a trailer which is made in accordance with the teachings of the preferred embodiment of the invention.

FIG. 2 is a perspective view of the trailer which is shown in FIG. 1.

FIG. 3 is a partial perspective unassembled view of the trailer which is shown in FIGS. 1 and 2 and which shows the top platform and storage box portion of the trailer.

FIG. 3A is a partial exploded view of the trailer which is shown in FIG. 3.

FIG. 4 is a perspective view of the storage box portion of the trailer which is shown in FIGS. 1-3.

FIG. 5 is a perspective top view of the storage box which is shown in FIG. 4 and more particularly, the storage box is shown in an a selected open position.

FIG. 6 is a partial perspective view of the trailer which is shown in FIGS. 1-4.

FIG. 7 is a partial perspective view of the trailer which is shown in FIGS. 1-4 and 6.

FIG. 8 is a partial unassembled perspective view of a portion of the trailer which is shown in FIGS. 1-4 and 6-7.

FIG. 9 is a top view of the trailer which is shown in FIGS. 1-4, 6, and 7.

FIG. 10 is a perspective view of a spacer which is made in accordance with the teachings of an alternate embodiment of the invention.

FIG. 11 is a partial perspective view of a trailer assembly made in accordance with the teachings of an alternate embodiment of the invention.

### DETAILED DESCRIPTION OF THE PREFERRED EMBODIMENT OF THE INVENTION

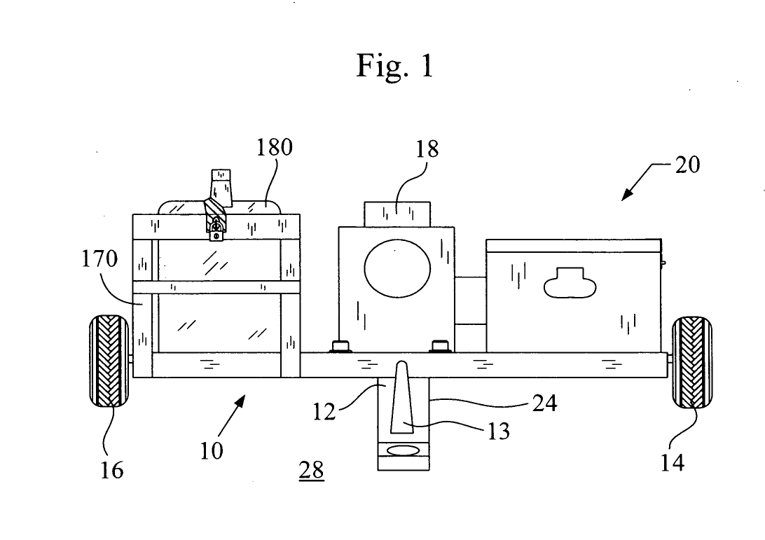

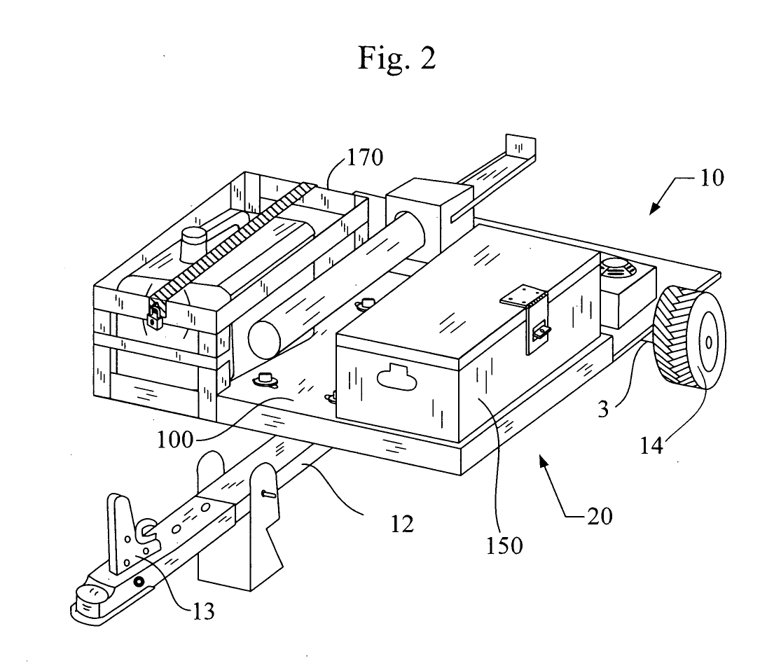

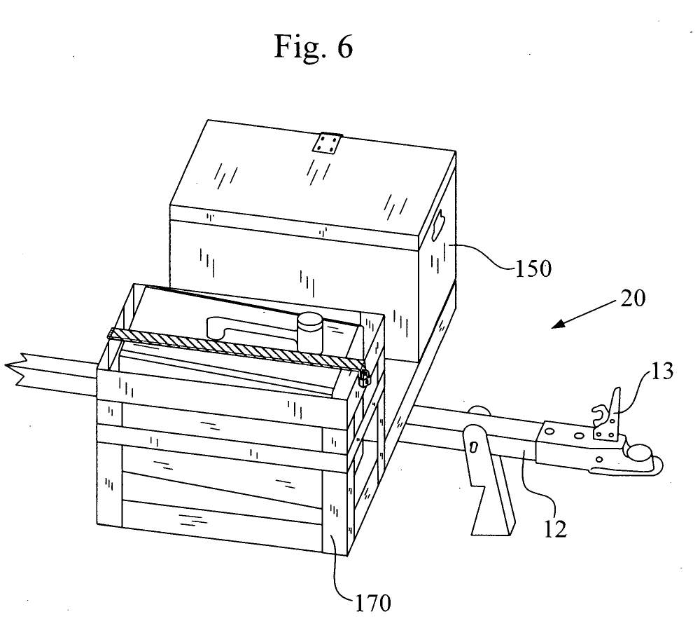

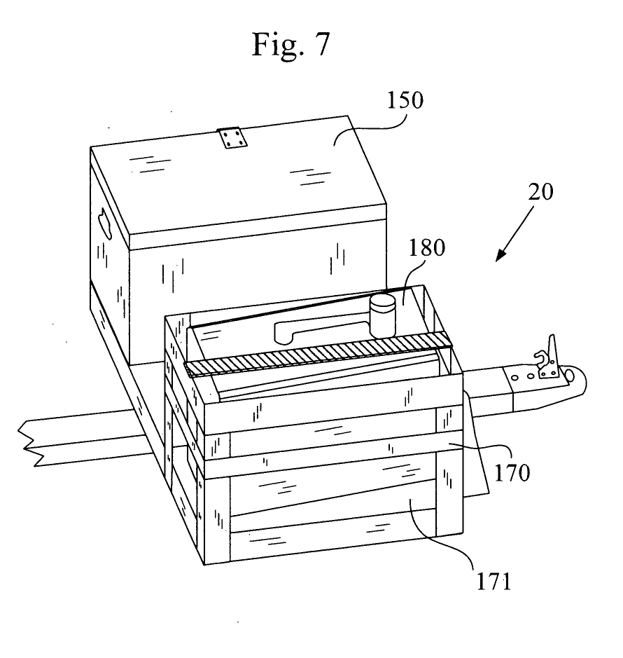

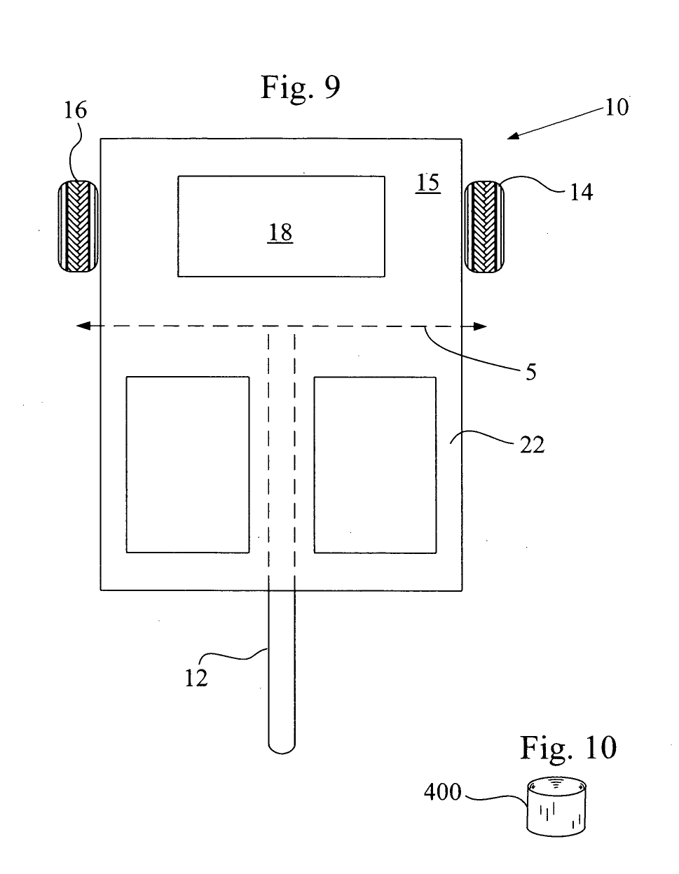

Referring now to FIGS. 1, 2, 6, 7, and 9 there is shown a trailer 10 which is made in accordance with the teachings of the preferred embodiment of the invention.

Particularly, the trailer 10 comprises an outwardly extending tongue portion 12 which includes a ball or outwardly protruding hitch portion 13 which is adapted to be selectively and removably coupled to a selectively moving assembly, such as a car or truck. The size and shape of portion 13 may vary. The tongue portion 12 is coupled to and/or integrally formed with an item carrying platform 15 and the platform 15 is coupled to a pair of wheels 14, 16 by axle 3 (e.g., each wheel 14,16 may be separately coupled to platform 15 by a separate axle 3). The platform 15, in this non-limiting example, supports a log splitter 18. It should be realized that nothing in this description is meant to limit the applicability of the present invention to a particular type of trailer. Rather, the log splitter “version” or type of trailer is just one non-limiting example of the type of trailer or functionality which may be used by the present invention. The principles of the present invention are generally applicable to a wide variety of dissimilar trailers, each of which includes some sort of projecting tongue portion which is coupled, in some manner (such as through an item carrying platform) to wheels.

In the most preferred embodiment of the invention, the trailer 10 further comprises a storage assembly 20 which is made in accordance with the teachings of the invention and which, as is more fully explained below, is coupled to the tongue portion 12 while engagingly abutting the item carrying or supporting platform 15 and which provides desired storage space.

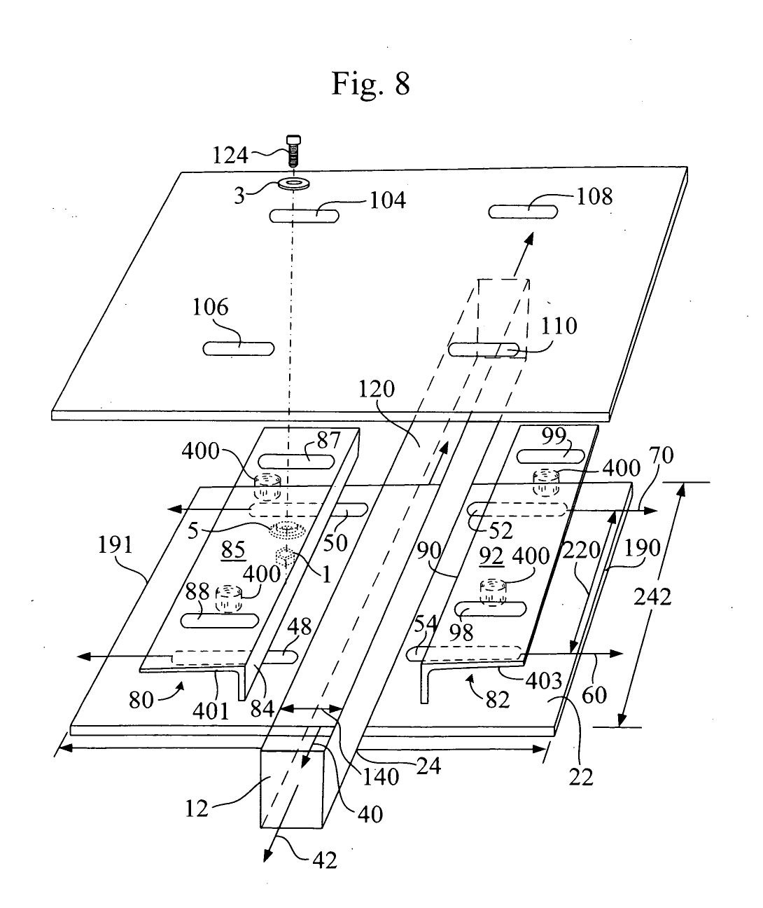

As is perhaps best shown in FIGS. 1-8, the assembly 20 includes a first generally flat plate member 22 which abuttingly engages an underside surface 24 of the tongue 12 (it should be realized that the term “underside surface” means the surface of the tongue 12 which is closes to the ground 28 upon which the wheels 14, 16 traverse).

The first plate member 22 abuttingly engages platform 15 along axis 5 and has a longitudinal axis of symmetry 40 and the tongue 12 also has a longitudinal axis of symmetry 42. When the plate member 22 engages the tongue 12, the longitudinal axis of symmetry 40 overlays the longitudinal axis of symmetry 42 and these axes 40, 42 are linearly coextensive (i.e., tongue 12 is made to lie upon longitudinal axis of symmetry 40). Further, the plate member 22 includes four substantially identical and generally elliptically shaped openings 48, 50, 52, and 54 and, in the most preferred embodiment of the invention, openings 48 and 54 lie along an axis 60 which is perpendicular to the longitudinal axis of symmetry 40 and the openings 50, 52 lie along an axis 70 which is parallel to the axis 60 and which is perpendicular to the longitudinal axis of symmetry 40. The axes 60, 70 are also linearly coextensive.

Further, the trailer storage assembly includes a pair of substantially identical L-shaped members 80, 82. Particularly, member 80 includes a first planar surface 84 which is adapted to abuttingly engage the tongue 12, and a second planar surface 85 which overlays the plate member 22 and forms a right angle with the surface 84. The surface 85 includes a pair of substantially identical and generally elliptically shaped openings 87, 88 and the openings 87, 88 are substantially identical to openings 48, 50, 52, and 54. The openings 87, 88 respectively overlay, communicate with and are registered with openings 50, 48. Similarly, the member 82 includes a first planar surface 90 which is adapted to abbuttingly engage the tongue 12 and a second planar surface 92 which is adapted to overlay the plate member 22 and which forms a right angle with the surface 92. The surface 92 includes substantially identical and generally elliptically shaped openings 98, 99 and the openings 98 and 99 are each substantially identical to openings 87, 88. Particularly, the openings 98, 99 respectively communicate with, are registered with, and overlay openings 54, 52.

The storage assembly 20 includes a top and generally flat plate member 100 which, in one non-limiting embodiment of the invention, is substantially identical to plate member 22. In one non-limiting embodiment, axes 40, 42 each comprise an axis of symmetry of plate members 100, 22 when the storage assembly 20 is assembled. That is, plate member 100 includes substantially identical and generally elliptically shaped openings 104, 106,108, and 110 and the plate member 100 is adapted to and does abuttingly engage the top surface 120 of the tongue 12. Openings 104,106,108, and 110 are each substantially identical to openings 48, 50, 52, and 54 and opening 104 overlays, is registered with, and communicates with each of the openings 87 and 50; opening 106 overlays, is registered with and communicates with each of openings 88 and 48; opening 108 overlays, is registered with and communicates with each of openings 94 and 52; and opening 110 overlays, is registered with and communicates with each of openings 98, 54. Thus openings 104, 87, and 50 are aligned and cooperatively form a first “set” of openings; openings 108, 52, and 99 are aligned and cooperatively form a second “set” of openings; openings 110, 98 and 54 are aligned and cooperatively form a third “set” of openings; and openings 106, 88, and 48 are aligned and cooperatively form a fourth “set” of openings. Further, openings 104, 108 lie along an axis 202 which is perpendicular to the axes 40, 42 while openings 106, 110 lie along an axis 206 which is parallel to axis 202 and perpendicular to axes 40, 42.

Fasteners such as bolts 124, 126, 128, and 130 may respectively and selectively traverse aligned openings 104, 87, 50; aligned openings 108, 52, and 99; aligned openings 110, 98, and 54; and aligned openings 106, 88. Particularly, each bolt 124-130 respectively traverses a washer 3 which resides upon plate 100. After respectively traversing these openings, each bolt 124-130 respectively receives a grommet 5 and a nut 1. In this manner, these bolts 124, 126, 128, and 130 cooperatively affix the plate 100 to the plate 22 while concomitantly securing the members 80, 82 between the secured plates 100, 22. Alternatively, members 80, 82 may be welded to the plate member 22 and the plate member 100 may be welded to the members 80, 82.

The openings 48, 50, 52, 54, 87, 88, 98, 99, 108, 104, 106, and 110 allow for the use of tongues 12 having a respective wide variety of dissimilar thicknesses 140. That is, if the thickness 140 is relatively wide, then the fasteners 124-130 respectively reside closer to one of the edges 190, 191. If the thickness 140 is relatively small, then the fasteners 124-130 respectively reside closer to the tongue 12. In the most preferred embodiment of the invention, the distance 220 between axes 60, 70 is over one half of the width 242 of the plate 22, thereby ensuring a stable fastening arrangement. The plates 100, 22 and members 80, 82 may each be welded to tongue 12 in another alternate embodiment.

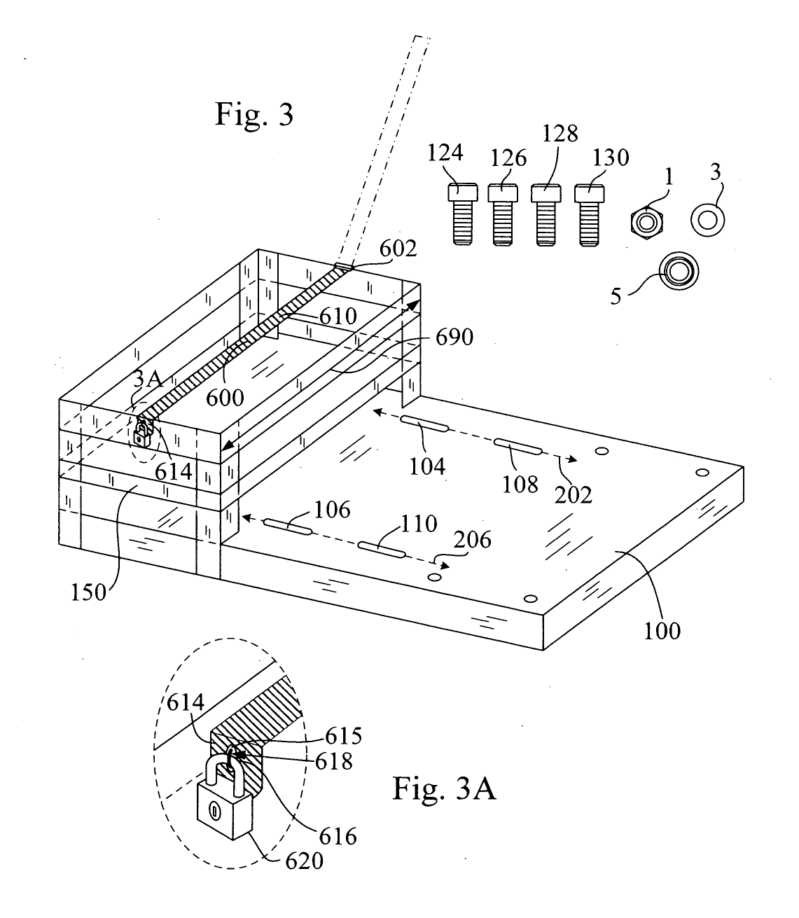

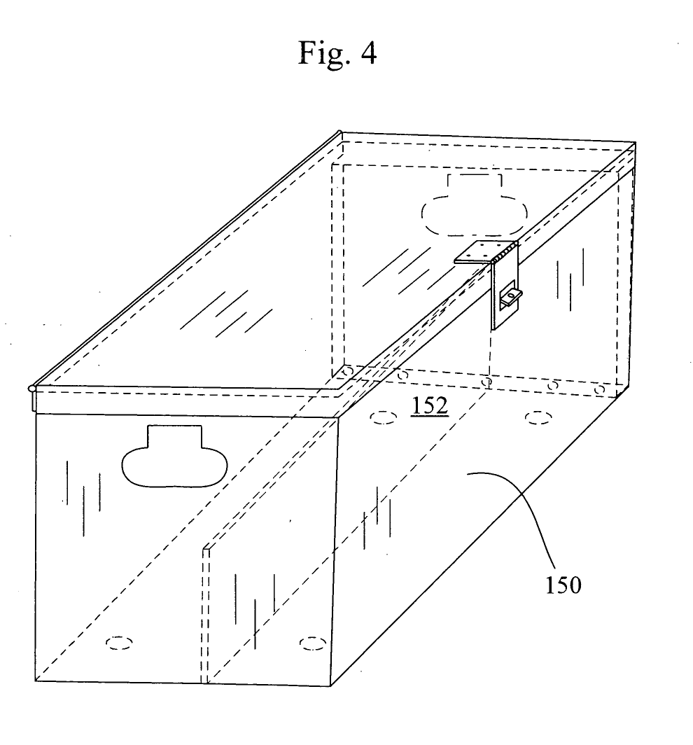

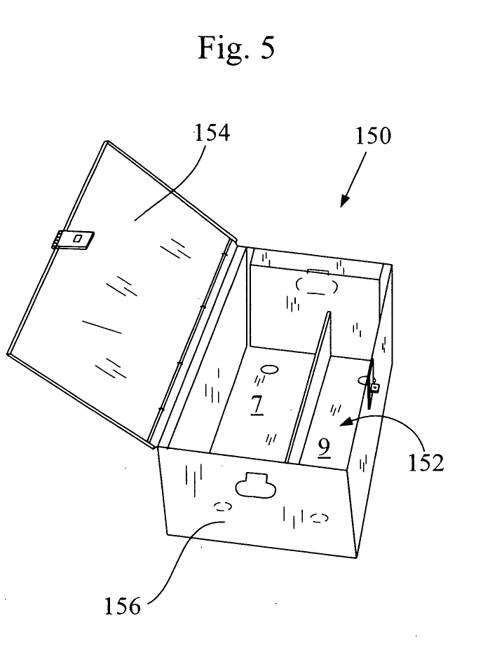

The storage assembly 20 as best shown in FIGS. 3-7 further includes a storage box 150 which may be bolted or otherwise joined to the plate member 100 and which includes an internal cavity 152 and a selectively movable top 154 which is movably coupled (e.g., by a hinge) to the body 156. Particularly, the top 154 is movable from a first closed position (as shown in FIG. 4) in which access to the internal cavity 152 is prevented, to an open position (as shown best in FIG. 5) in which access to the internal cavity 12 is allowed. The storage box 150 may be used to store a wide variety of items and the box 152 may have a plurality of compartments e.g., compartment 7,9 having different sizes and shapes.

The storage assembly 20 further includes an open storage bin 170 which may be fastened (e.g., welded) to the top plate 100 and which may be used to store a gasoline container 180 or a wide variety of other containers within the internal cavity 171 of the bin 170. It should be appreciated that a trailer having such an assembly 20 may be sold as a single unit and/or the assembly 20 may be sold separately in the aftermarket.

In a first non-limiting alternate embodiment of the invention, a plurality of substantially identical spacers, such as spacer 400, may selectively be utilized (see FIG. 10). That is, each such spacer 400 may be of a cubic or a rectangular shape (the cubic shape is shown) and be made of rubber or some other selectively compressible material. In this alternate non-limiting embodiment, four such spacers 400 are used and are each deployed upon surface 22. Particularly, in one non-limiting embodiment, two of these spacers 400 are deployed under and adhered to surface 401 of member 80 and two of these spacers 401 are deployed under and adhered to surface 403 of member 82. Such adherence may be achieved by the use of glue or some other type of adhesive and these four spacers 400 prevent or reduce the likelihood of undesirable bending of surfaces 85, 92 toward surface 22. Importantly, the spacers 400 are deployed such that they are remote from any of the generally elliptical openings. In yet another non-limiting embodiment, each spacer 400 receives a unique one of the bolts 124-130 and each bolt 124-130 traverses through a unique spacer 400.

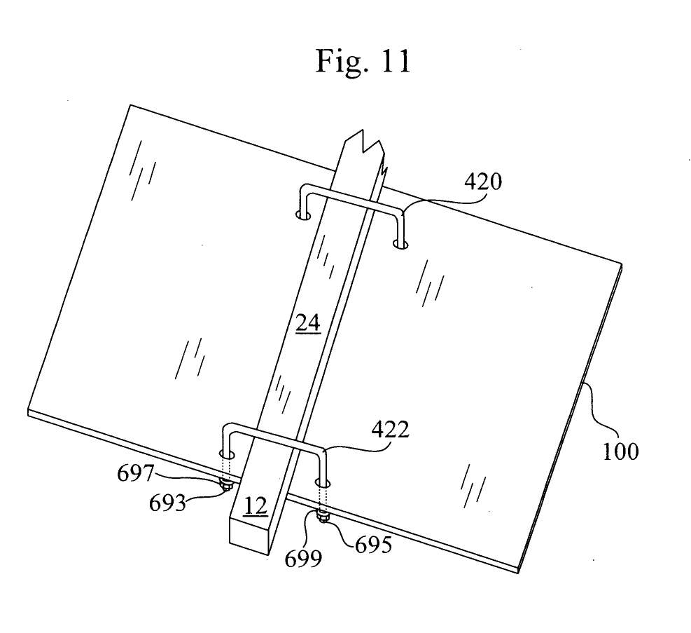

Referring now to FIG. 11, in an alternate although non-limiting embodiment of the invention, the L-shaped members 80, 82 and plate member 22 are eliminated, and the top plate member 100 is attached to the tongue 12 by twp substantially similar U-bolts 420, 422. Particularly, each bolt “captures” the tongue 12 and pierces the plate 100 (e.g., such piercing is respectively accomplished by respective arms 693, 695 and each such pierced arm 693, 695 respectively receives a nut 697, 699, or other connector device.

In yet another non-limiting embodiment of the invention, as best shown in FIG. 3, a bar 600 is utilized and is coupled to open storage bin 170 by the use of hinge 602 and is therefore selectively movable from a first position remote from the box 170 (shown in phantom) to a lower position as shown in FIG. 3. Further, the bar 600 includes a body 610 which traverse the length 693 of the bin 170 and a downwardly protruding portion 614 which includes an opening 615. The box 170 includes a projecting portion 616 which is adapted to be selectively inserted into and received by the opening 615 and the portion 616 is adapted, by an opening 618, to receive a padlock 620 which will prevent the bar 600 from being placed into the open position. Thus, the gas can 180 (or a similar item) cannot be removed from the bin 170 and the bin 170 is locked.

It is to be understood that the invention is not limited to the exact construction or method illustrated above, but that various changes and modifications may be made without departing from the spirit and the scope of the inventions as they are more fully delineated in the following claims. It should be fully appreciated that the present inventions are adapted for use with a wide variety of dissimilar trailers having a wide variety of shapes, sizes, and uses.

What is claimed is:

1) A trailer comprising a tongue portion; a wheel assembly which is coupled to said tongue portion; a first plate having a longitudinal axis of symmetry which abuttingly engages a first surface of said tongue portion and which includes four substantially identical elliptically shaped openings, wherein a first pair of said four substantially identical elliptically shaped openings reside on a second axis which is perpendicular to said longitudinal axis of symmetry, wherein said first surface further including a second pair of elliptically shaped openings and wherein said second pair of said four substantially identical elliptically shaped openings reside on a third axis which is perpendicular to said longitudinal axis of symmetry and parallel to said second axis and wherein said tongue portion lies along said longitudinal axis of symmetry; first and second substantially identical L-shaped members, wherein a first of said L-shaped members has a first planar surface which abuttingly engage said tongue portion and a second projecting surface which is parallel to and which overlays said first plate, wherein said second projecting surface includes fifth and sixth substantially identical elliptically shaped openings and wherein said fifth elliptically shaped opening communicates with, is registered with, and overlays a unique one of said first pair of said four substantially identical elliptically shaped openings, when said sixth elliptically shaped opening communicates with, is registered with, and overlays a second one of said first pair of said four substantially identical elliptically shaped openings, and when said second of said L-shaped members has a first planar surface which abbutingly engages said tongue portion and a second projecting surface which is parallel to and which overlays said first plate, wherein said second projecting surface of said second L-shaped member includes seventh and eighth substantial identical elliptically shaped openings and wherein said seventh elliptically shaped opening communicates with, is registered with, and overlays a unique one of said second pair of said four substantially identical elliptically shaped openings, wherein said eighth elliptically shaped opening communicates with, is registered with, and overlays a second one of said second pair of said four substantially identical elliptically shaped openings; a second plate which abuttingly engages and overlays said respective second projecting surface of said first and second L-shaped members, wherein said second plate includes substantially identical ninth, tenth, eleventh, and twelfth generally elliptical openings and wherein said ninth opening communicates with, is registered with, and overlays said fifth opening, said tenth opening communicates with, is registered with, and overlays said sixth opening, said eleventh opening communicates with, is registered with, and overlays seventh opening, and said twelfth opening overlays, communicates with, is registered with said eighth opening; and first, second, third, and fourth substantially identical fasteners, which respectively and fastenably transverse unique sets of overlayed elliptically shaped openings and which cooperatively fasten said first plate to said second plate and said L-shaped members to said second plate.

2) The trailer assembly of claim 1 further comprising or storage box which is affixed to said second plate, wherein second storage box includes an internal storage cavity and a top which is movaable from a first open position in which access to said internal cavity is allowed to a second closed position.

3) The trailer assembly of claim 2 further comprising holder which is adapted to effectively receive an item.

4) The trailer assembly of claim 3 wherein said ninth and tenth opening lie along a fourth axis which is perpendicular to said longitudinal axis of symmetry and wherein said eleventh and twelfth openings lie along a fifth axis which is perpendicular to said longitudinal axis of symmetry and parallel to said fourth axis.

5) The trailer assembly of claim 4 wherein the distance between said second and third axes is over one half of the width of said first plate.

6) A trailer storage assembly for use in combination with a trailer of the type having a tongue and a wheel assembly which is coupled to said tongue, said trailer storage assembly comprising a first plate having a longitudinal axis of symmetry which abuttingly engages a first surface of said tongue portion and which includes four substantially identical elliptically shaped openings, wherein a first pair of said four substantially identical elliptically shaped openings reside on a second axis which is perpendicular to said longitudinal axis of symmetry and wherein said first surface further including a second pair of elliptically shaped openings and wherein said second pair of said four substantially identical elliptically shaped openings reside on a third axis which is perpendicular to said longitudinal axis of symmetry and parallel to said second axis and wherein said tongue portion lies along said longitudinal axis of symmetry; first and second substantially identical L-shaped members, wherein a first of said L-shaped members has a first planar surface which abuttingly engage said tongue portion and a second projecting surface which is parallel to and which overlays said first plate, wherein said second projecting surface includes fifth and sixth substantially identical elliptically shaped openings and wherein said fifth elliptically shaped opening communicates with, is registered with, and overlays a unique one of said first pair of said four substantially identical elliptically shaped openings, wherein said sixth elliptically shaped opening communicates with, is registered with, and overlays a second one of said first pair of said four substantially identical elliptically shaped openings, and wherein said second of said L-shaped members has a first planar surface which abbutingly engages said tongue portion and a second projecting surface which is parallel to and which overlays said first plate, wherein said second projecting surface of said second L-shaped member includes seventh and eighth substantial identical elliptically shaped openings and wherein said seventh elliptically shaped opening communicates with, is registered with, and overlays a unique one of said second pair of said four substantially identical elliptically shaped openings, wherein said eighth elliptically shaped opening communicates with, is registered with, and overlays a second one of said second pair of said four substantially identical elliptically shaped openings; a second plate which abuttingly engages and overlays said respective second projecting surface of said first and second L-shaped members, wherein said second plate includes substantially identical ninth, tenth, eleventh and twelfth generally elliptical openings and wherein said ninth opening communicates with, is registered with, and overlays said fifth opening, said tenth opening communicates with, is registered with, and overlays said sixth opening, said eleventh opening communicates with, is registered with, and overlays said seventh opening, and said twelfth opening overlays, communicates with, is registered with said eighth opening; and first, second, third, and fourth substantially identical fasteners, which respective and fastenably transverse unique sets of overlayed elliptically shaped openings and which cooperatively fasten said first plate to said second plate and said L-shaped members to said second plate.

7) The trailer assembly of claim 5 further comprising or storage box which is affixed to said second plate, wherein second storage box includes an internal storage cavity and a top which is movaable from a first open position in which access to said internal cavity is allowed to a second closed position.

8) The trailer assembly of claim 7 further comprising holder which is adapted to effectively receive an item.

9) The trailer assembly of claim 8 wherein the distance between said second and third axes is over one half of the width of said first plate.

10) The trailer assembly of claim 9 wherein said ninth and tenth opening lie along a fourth axis which is perpendicular to said longitudinal axis of symmetry and wherein said eleventh and twelfth openings lie along a fifth axis which is perpendicular to said longitudinal axis of symmetry and parallel to said fourth axis.

11) A trailer assembly, for use with a trailer of the type having a tongue and comprising a plate which engages said tongue; and a pair of fasteners which fasten said plate to said tongue.

12) The trailer assembly of claim 11 wherein said pair of fasteners comprises a pair of substantially identical U-bolts.

13) The trailer assembly of claim 12 further comprising a storage box which is coupled to said plate.

14) The trailer assembly of claim 13 further comprising an open bin which is coupled to said plate.

15) The trailer assembly of claim 14 further comprising a bar which is hingedly coupled to said open bin; wherein said bar includes a first portion having an opening and said bin includes a protruding portion which selectively traverses said opening of said first portion and which includes an opening; and a lock which traverses said opening of said protruding portion thereby preventing said bar from being raised above said open bin.
